(19) United States
(12) Patent Application Publication
(10) Pub. No.: US 2017/0015894 A1
(43) Pub. Date: Jan. 19, 2017

(54) METHOD FOR CO2-FLOODING USING ALK(EN)YL POLYGLUCOSIDES

(71) Applicant: BASF SE, Ludwigshafen (DE)

(72) Inventors: Christian BITTNER, Bensheim (DE); Benjamin WENZKE, Hamburg (DE); Guenter OETTER, Hamburg (DE); Sebastian A. WEISSE, Viernheim (DE)

(21) Appl. No.: 15/124,959

(22) PCT Filed: Mar. 6, 2015
(86) PCT No.: PCT/EP2015/054778

§ 371 Date: Sep. 9, 2016

(30) Foreign Application Priority Data
Mar. 12, 2014 (EP) 14159154.5

(51) Int. Cl. C09K 8/584; E21B 43/24; E21B 43/16; C09K 8/594; C09K 8/58

(52) U.S. Cl. CPC C09K 8/584; C09K 8/594; C09K 8/58; E21B 43/164; E21B 43/24

(57) ABSTRACT

A method for mineral oil production by means of CO₂ flooding, in which liquid or supercritical CO₂ and at least one alk(en)yl polyglucoside are injected through at least one injection well into a mineral oil deposit and mineral oil is withdrawn from the deposit through at least one production well. The alk(en)yl polyglucoside is preferably dissolved in the CO₂ phase. A method for mineral oil production by means of CO₂ flooding, in which mixtures of the alk(en)yl polyglucosides with alk(en)yl polyalkoxylates or anionic surfactants are used.

The invention relates to a method for mineral oil production by means of CO₂ flooding, in which liquid or supercritical CO₂ and at least one alk(en)yl polyglucoside are injected through at least one injection well into a mineral oil deposit and mineral oil is withdrawn from the deposit through at least one production well. The alk(en)yl polyglucoside is preferably dissolved in the CO₂ phase. The invention further relates to a method for mineral oil production by means of CO₂ flooding, in which mixtures of the alk(en)yl polyglucosides with alkyl polyalkoxylates or anionic surfactants are used.

In natural mineral oil deposits, mineral oil is present in the cavities of porous reservoir rocks which are sealed toward the surface of the earth by impervious top layers. The cavities may be very fine cavities, capillaries, pores or the like. Fine pore necks may have, for example, a diameter of only about 1 μm. As well as mineral oil, including fractions of natural gas, a deposit typically comprises water with a greater or lesser salt content.

After commencement of drilling in a mineral oil deposit, mineral oil may first of all flow of its own accord through the well to the surface because of the autogenous pressure of the deposit.

The autogenous pressure can be caused by gases present in the deposit, such as methane, ethane or propane. This mode of production is usually referred to as primary mineral oil production. By means of primary production, according to the deposit type, however, it is usually possible to produce only approx. 5 to 10% of the amount of mineral oil present in the deposit; thereafter, the autogenous pressure is no longer sufficient for production. There are also deposits in which the autogenous pressure is not sufficient from the start for primary production.

In order to produce even more mineral oil from a deposit, measures for secondary and/or tertiary mineral oil production are employed.

In secondary production, in addition to the boreholes which serve for the production of the mineral oil, called the production wells, further boreholes are drilled into the mineral oil-bearing formation, Water is injected into the deposit through these so-called injection wells in order to maintain the pressure or to increase it again. As a result of the injection of the water, the mineral oil is forced gradually through the cavities into the formation, proceeding from the injection well in the direction of the production well. However, this only works for as long as the cavities are completely filled with oil and the more viscous oil is pushed onward by the water. As soon as the mobile water breaks through cavities, it flows on the path of least resistance from this time, i.e. through the channel formed, and no longer pushes the oil onward. By means of primary and secondary production, generally only approx. 30 to 35% of the amount of mineral oil present in the deposit can be produced.

An overview of tertiary oil production can be found, for example, in “Journal of Petroleum Science of Engineering 19 (1998)”, pages 265 to 280. Tertiary oil production includes thermal processes in which hot water or steam is injected into the deposit. This lowers the viscosity of the oil. Tertiary mineral oil production also includes methods in which suitable chemicals, for example surfactants or thickening polymers, are used as assistants for oil production. These can be used to influence the situation toward the end of water flooding and as a result also to produce mineral oil hitherto held firmly within the rock formation. There are additionally known techniques for enhancing oil production by injecting gases such as CO₂, N₂ or CH₄ into the formation.

What is called CO₂ flooding involves injecting liquid or supercritical CO₂ into a mineral oil formation through one or more injection wells, which flows therefrom in the direction of the production wells and as it does so mobilizes mineral oil still present in the formation. Mobilized mineral oil is withdrawn from the production wells. This technique is also known as “CO₂ enhanced oil recovery (EOR)” or “CO₂ improved oil recovery (IOR)” and has great economic significance: At present, more than 5% of crude oil production in the USA is obtained by means of CO₂ flooding (R. M. Enick, D. K. Olsen, “Mobility and Conformance Control for Carbon Dioxide Enhanced Oil Recovery (CO₂-EOR) via Thickeners, Foams, Gels—A Detailed Literature Review of 40 Years of Research”, page 910, SPE 154122, 18^{th} SPE Improved Oil Recovery Symposium, Tulsa, Okla., USA, Apr. 14-18, 2012, Society of Petroleum Engineers, 2012).

Various mechanisms are responsible for the enhanced oil production by pumping of liquid or supercritical CO₂ into a deposit. CO₂ is soluble in mineral oil and lowers the viscosity thereof. It is self-evident that lower-viscosity oil can be produced better than high-viscosity oil. The CO₂ dissolved in the oil can additionally swell the oil, and a coherent oil bank forms more readily. Another production mechanism may be the dissolution of preferentially light fractions of crude oil in the CO₂ phase—in other words, a kind of extraction. A further aspect is the low interfacial tension between crude oil and liquid or supercritical CO₂, which helps to overcome capillary forces: an oil droplet can more easily deform in a CO₂ phase and pass through narrow pore necks than it could in a water phase.

When CO₂ is pumped into a deposit, the pressure and temperature decide the physical state thereof. The critical point of CO₂ is at 30.98° C. and 73.75 bar. Above these values, CO₂ is supercritical, meaning that it is nearly as dense as a liquid but still has a very low viscosity similar to that of a gas. The viscosity of supercritical CO₂ is generally several orders of magnitude lower than that of the oil in the deposit.

The low viscosity of supercritical CO₂ is one of the central problems with CO₂ flooding and makes it considerably more difficult to control the mobility of CO₂ in the deposit. In order to achieve a good deoiling effect, the CO₂ should flow in a homogeneous front from the injection well in the direction of the production well and, as it does so, flow through all the regions of the formation (still) filled with oil. However, this is only very rarely the case in practice.

Firstly, the porosity of an underground oil deposit is generally not homogeneous, and, as well as fine-pore regions, an underground mineral oil formation may also have regions of high porosity, clefts or fractures. Furthermore, even given the same porosity, the flow resistance for CO₂ in regions of the formation still filled with oil is much greater than the flow resistance of regions that have already been deoiled. There is thus the risk that the injected CO₂ will not flow through regions of the formation still filled with oil at all, but will instead flow to little effect through regions of low flow resistance directly from the injection well to the production well. This effect is also called “fingering” and is shown in schematic form in FIG. 1.

The “breakthrough” of CO₂ to the production well reduces the economic viability of CO₂ flooding to a quite considerable degree, since a greater or lesser portion of the CO₂ injected then flows through the formation to little effect. Either more CO₂ is then required, or the CO₂ produced, after the production of mineral oil or formation water, has to be separated, cleaned and compressed again, so that it can be reinjected.

Secondly, the density of liquid or supercritical CO₂ is also much lower than the density of mineral oil and formation water. Because of buoyancy, CO₂ preferentially collects in the upper layers of the formation or preferentially flows through the upper layers. The deoiling is thus preferentially effected in the upper layers of the formation, while lower layers are not reached at all by the CO₂.

The prior art has proposed various procedures for achieving homogeneous—both horizontal and vertical—flow of CO₂ through mineral oil deposits. For example, alternating injection of water and CO₂ into the mineral oil formation has been proposed. The so-called “Water-Alternating-Gas” process (described by D. W. Green and G. P. Willhite in “Enhanced Oil Recovery” SPE Textbook Series Vol. 6 from 1998) is an established process in flooding with CO₂.

There have additionally been proposals to thicken the injected CO₂ in order to match the viscosity of the CO₂ to the viscosity of the mineral oil. In this regard, U.S. Pat. No. 4,852,651 proposes, for example, the addition of particular polysilicones. Huang et al., Macromolecules, 2000, vol. 33 (15), pages 5437 to 5442, propose the use of styrene-fluoroacrylate copolymers. The moderate solubility of many polymers in CO₂ and the high addition of a further solvent, however, make the process appear uneconomic.

In a further, known technique, suitable surfactants are used in order to form CO₂-in-water emulsions or CO₂-in-water foams from CO₂ and formation water and/or injected water in the deposit. In CO₂-in-water emulsions, the CO₂ is in a discontinuous phase, while water forms the continuous phase. Emulsions of this kind have a much higher viscosity than supercritical or liquid CO₂ and thus no longer follow only the paths of lowest flow resistance, but instead flow much more homogeneously through the formation. Mobility control through formation of CO₂-in-water emulsions allows enhanced exploitation of the deposit by macroscopic displacement (mobility control) and microscopic displacement (CO₂-oil interfacial tension).

The demands on surfactants for CO₂ flooding are distinctly different than demands on surfactants for other applications, for example detergent applications; however, they also differ, more particularly, from the demands on surfactants for surfactant flooding, i.e. an EOR technique in which aqueous solutions of surfactants but no CO₂ are injected into the deposit.

The primary task of the surfactants in surfactant flooding is to reduce the water-mineral oil interfacial tension. Thus, mineral oil droplets enclosed in the formation are mobilized.

The primary task of the surfactants in CO₂ flooding with formation of CO₂-in-water emulsions, in contrast, is to stabilize the CO₂-water interfaces in order thus to generate CO₂-in-water emulsions of prolonged stability in the deposit. The hydrophobic radicals of the surfactants project into the aqueous or supercritical CO₂ phase and therefore have to have good interaction with the CO₂, in order to give good stabilization of the CO₂-water interface.

In addition, the formation of CO₂-in-water emulsions has to be assured at the customary deposit temperatures (typically about 15° C. to 130° C.) and in the presence of water of high salt content, especially also in the presence of high proportions of calcium and/or magnesium ions. If the high-viscosity CO₂-in-water emulsion collapses, the low-viscosity supercritical CO₂, as described above, preferentially follows the paths of least flow resistance and/or collects in the upper regions of the formation.

In addition, suitable surfactants must also have sufficient solubility and sufficient stability in deposit water and/or injected water. The water is acidic as a result of dissolved CO₂ (pH values of about 3). Suitable surfactants therefore also have to be soluble in the acidic environment and have sufficient long-term stability against hydrolysis. Popular surfactants for surfactant flooding, such as alkyl sulfates or alkyl ether sulfates, are therefore not very suitable for CO₂ flooding, since they are firstly more insoluble as a result of protonation, and the sulfate group can be eliminated by hydrolysis under the conditions mentioned. Compounds containing amide groups are also susceptible to hydrolysis under the conditions mentioned.

Finally, the tendency of the surfactants to be adsorbed by the rock should be at a minimum, in order to minimize the loss of surfactant.

The prior art has already proposed a large number of surfactants for various techniques for CO₂ flooding.

U.S. Pat. No. 3,342,256 describes the improvement of oil production with the aid of CO₂ and a surfactant for mobility control. The surfactant can be injected either via the CO₂ phase or via the water phase. Suitable surfactants include octylphenol ethoxylates, dioctyl sulfosuccinate sodium salt, lauryl sulfate sodium salt or isopropyl naphthalenesulfonate sodium salt.

U.S. Pat. No. 4,113,011 describes a method for oil production with injection of CO₂ and an aqueous surfactant solution. A surfactant disclosed is an alkyl ether sulfate of the RO-EO-sulfate type, formed from an alcohol having 9 to 11 carbon atoms and 1 to 5 DO units. Reference is made to a higher salt tolerance compared to the use of alkyl sulfates. Sulfates, however, do not have sufficient long-term stability to hydrolysis under the conditions of CO₂ flooding.

U.S. Pat. No. 4,380,266 describes a method for mineral oil production by injection of a mixture of CO₂ and EO-PO block polymers or alkyl ethoxylates or alkylphenol ethoxylates or alkyl alkoxylates, with the conditions selected such that the CO₂ is liquid under the deposit conditions. An example mentioned is Polytergent® SL-62. This is a linear alcohol having 6 to 10 carbon atoms which has been propoxylated and ethoxylated.

U.S. Pat. No. 4,637,466 describes the use of alkyl ether carboxylates of the RO-(AO)ₓR′COOM type for CO₂ flooding, where R is a linear or branched alkyl radical having 8 to 24 carbon atoms, AO is ethylene oxide or propylene oxide. R′ is a methylene or ethylene radical and x is a number from 3 to 11.

U.S. Pat. No. 5,033,547 discloses a method for oil recovery by injecting a mixture of CO₂ and a surfactant into a mineral oil formation, wherein an emulsion of CO₂, water and the surfactant is formed together with formation water in the formation. The surfactants are alkyl ethoxylates or alkylphenol ethoxylates having a hydrophobic radical having 7 to 15 carbon atoms and an ethoxylation level of 4 to 8.

DE 30 454 26 A1 discloses the improvement of oil production by the injection of gaseous CO₂ and surfactant to form a foam.

U.S. Pat. No. 5,046,560 discloses a method for oil production by injecting a gas selected from the group of hydrocarbons, inert gases, steam and carbon dioxide, and an aqueous alkylarylpolyalkoxysulfonate solution. The sulfonate group is on the aryl radical.

DE 32 086 62 A1 discloses a method for oil production, by injecting a formulation comprising water, CO₂ and nonionic surfactants. Examples of surfactants include alcohol ethoxylates based on octylphenol, nonylphenol or C₁₂C₁₅ alcohol.

U.S. Pat. No. 7,842,650 describes a method for mineral oil production, which comprises the production of foams from liquids using a surfactant mixture of a foam former (a) selected from the group of sulfates, sulfonates, phosphates, carboxylates, sulfosuccinates, betaines, quaternary ammonium salts, amine oxides, amine ethoxylates, amide ethoxylates, acid ethoxylates, alkyl glucosides, EO-PO block copolymers and long-chain fatty alcohol ethoxylates, and a co-surfactant (b) of the general formula RO-(AO)_{y}—H or RO-(AO)_{y}—Z, where R is a hydrocarbyl radical having 6 to 12 carbon atoms, (AO)_{y} is an alkyleneoxy block, y is a number from 5 to 25 and Z is an anionic group (e.g. sulfate, sulfonate or carboxylate). One example given for a formulation having enhanced foam formation is the mixture of cocoamidopropyl betaine with C₁₀-Guerbet alcohol-14 EO. The method is preferably a method for tertiary mineral oil production.

U.S. Pat. No. 4,856,588 discloses a method for oil production from underground mineral oil formations having one or more aqueous, essentially oil-free zones and one or more zones of high oil saturation, by injecting a mixture comprising (i) water, (ii) a component selected from supercritical CO₂, gaseous nitrogen, gaseous CO₂ and C₁ to C₃ hydrocarbons or mixtures thereof, and (iii) polysaccharide surfactants of the general formula RO(R¹O)ₓSacc_{z} where R is a hydrocarbyl radical having 7 to 24 carbon atoms, R¹ is C₂- to C₄-alkylene, x is 0 to 12 and z is 0.7 to 10. Sacc is a sugar residue. In a preferred embodiment of the invention, an aqueous solution of the surfactants (iii) is injected first, followed by the components (ii). Preferably, R comprises C₉ to C₁₅ hydrocarbyl radicals.

WO 2010/044818 A1 describes a method for mineral oil production by CO₂ flooding by injection of a nonionic surfactant having a CO₂-philicity of 1.5 to 5.0 into the formation, where the surfactant should form a stable foam with formation water but should not form an emulsion with crude oil. The nonionic surfactant preferably has the formula RO-(AO)ₓ-(EO)_{y}—H where AO represents an alkoxy group having 3 to 10 carbon atoms and EO represents ethoxy groups, where the following combinations may be selected for R, AO, x and y:

| R | AO | x | y |
|---|---|---|---|
| branched alkyl, alkylaryl or cycloalkyl | C₃ | 1.5-11 | 6-25 |
| radical having 3 to 11 carbon atoms | C₄ to C₁₀ | 1-2 | 6-25 |
| linear alkyl radical having 3 to 6 carbon | C₃ | 4-11 | 6-25 |
| atoms | C₄ to C₁₀ | 1-2 | 6-25 |

Particular preference is given to the use of surfactants selected from the group of C₈H₁₇—(PO)₅-(EO)₉—H, C₈H₁₇—(PO)₅-(EO)₁₁—H, C₈H₁₇—(PO)₉-(EO)₉—H, C₆H₁₃—(PO)₅-(EO)₁₁—H, C₆H₁₃—(PO)₅-(EO)₁₃—H, C₉H₁₉—(PO)₄-(EO)₈—H or mixtures thereof.

WO 2011/005246 A1 describes surfactants for mineral oil production, which can be injected into a deposit together with CO₂ and water. The nonionic surfactants are glycerol derivatives, where two of the alcohol groups of glycerol have been capped with a hydrocarbyl radical which may comprise 4 to 18 carbon atoms. The third alcohol group may be ethoxylated, propoxylated or butoxylated, and may have an alkoxylation level of 9 to 40.

WO 2011/152856 A1 discloses a method for oil production with the aid of supercritical CO₂ and a surfactant, which is injected into a CO₂ stream and dissolved in the CO₂. In the deposit, an emulsion forms from deposit water, surfactant and CO₂. The following are used, by way of example: nonionic surfactants (e.g. alkylphenol ethoxylates), cationic surfactants (for example ethoxylated tallow fatty amine), anionic surfactants (e.g. alkyl ether sulfates) or betaine surfactants.

WO 2012/170835 A1 claims a method in which a nonionic surfactant formulation having a pour point of −3 to −54° C. is used, is dissolved in CO₂, and is injected into the formation to form emulsions with water. For lowering of the pour point, alcohols such as methanol, ethanol, glycol or glycol ethers are proposed.

WO 2013/043838 A1 describes an oil production method with liquid or supercritical surfactant and an alkoxylated amine based on a secondary alkyl radical having 4 to 30 carbon atoms.

WO 2013/048860 A1 describes a method for mineral oil production, which claims the use of CO₂ and an alkyl alkoxylate based on a branched alkyl radical having 3 to 9 carbon atoms and alkoxylation by means of double metal cyanide catalysis.

Tertiary mineral oil production by means of CO₂ flooding is an industrial scale process. Although the surfactants are used only as dilute solutions in water or CO₂, the volumes injected per day are high and the injection is typically continued over months and up to several years. The surfactant requirement for an average oilfield may be about 2000 to 3000 t/a. Even an only slightly better surfactant can considerably enhance the economic viability of CO₂ flooding.

As described above, a viscous CO₂-in-water emulsion should form in the course of CO₂ flooding. In the CO₂-in-water emulsion, water forms the continuous phase and hence functions as a buffer between discrete CO₂ phases. If the CO₂-in-water emulsion loses water, this leads at some point to combination of the discrete CO₂ phases, meaning that the CO₂-in-water emulsion breaks down. Breakdown of the emulsion in the mineral oil formation is highly undesirable, since it is specifically the higher viscosity of the emulsion compared to a pure CO₂ phase that is required for avoidance of “fingering”.

The demands on surfactants depend on the deposit temperatures, especially on the salinity of the deposit water and the deposit temperature. While many surfactants still give satisfactory results at low salinities and/or low deposit temperatures, they do not give good results at high temperatures and/or high salinities.

The problem addressed by the invention was that of providing an improved method for CO₂ flooding, especially for mineral oil deposits having high salinity and/or high deposit temperature. Stable CO₂-in-water emulsions should still form even under such demanding conditions.

Accordingly, a method has been found for mineral oil production by means of CO₂ flooding, in which liquid or supercritical CO₂ and at least one nonionic surfactant (I) or a surfactant mixture comprising at least one nonionic surfactant (I) are injected through at least one injection well into a mineral oil deposit and crude oil is withdrawn from the deposit through at least one production well, wherein the at least one surfactant (I) or the surfactant mixture comprising at least one surfactant (I) has been dissolved in liquid or supercritical CO₂ and is injected and/or has been dissolved in an aqueous medium and is injected, the deposit has a deposit temperature of 15° C. to 140° C., the deposit water has a salinity of 20 000 ppm to 350 000 ppm, the density of the CO₂ under deposit conditions is 0.65 g/ml to 0.95 g/ml, and wherein the at least one nonionic surfactant is an alk(en)yl polyglucoside of the general formula (I)

R¹—O—(R²)ₚ—H (I)
where
R¹ is a linear or branched, saturated or unsaturated aliphatic hydrocarbyl radical having 8 to 18 carbon atoms, preferably 8 to 16, carbon atoms.
R² represents sugar units having 5 or 6 carbon atoms, and
p is a number from 1 to 5.

### LIST OF DRAWINGS

FIG. 1: Schematic diagram of “fingering” in the course of CO₂ flooding.

FIG. 2: Schematic diagram of the high-pressure reactor with sightglasses used for the examples and comparative examples.

FIG. 3: View through sightglass in the high-pressure reactor before mixing: CO₂ phase and water phase (schematic diagram).

FIG. 4: View through sightglass in the high-pressure reactor after mixing: CO₂ phase, CO₂-in-water emulsion and water phase (schematic diagram).

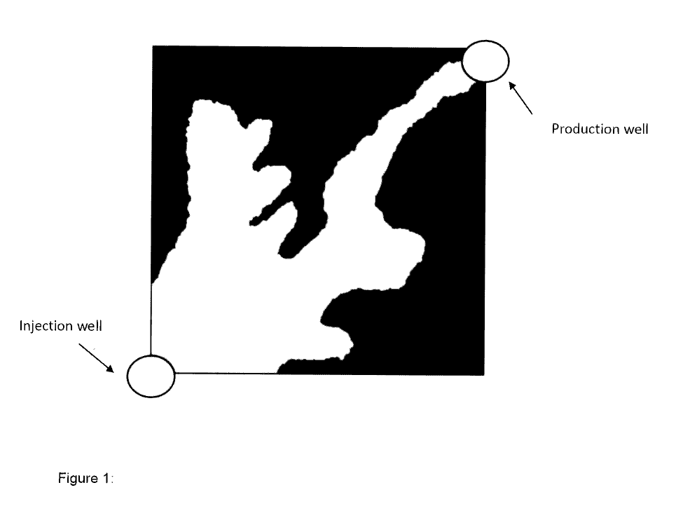

Specific details of the invention are as follows:

In the method of the invention for mineral oil production by means of CO₂ flooding, liquid or supercritical CO₂ and, as a nonionic surfactant (I), at least one alk(en)yl polyglucoside (I) are injected into a mineral oil deposit. As well as the alk(en)yl polyglucoside (I), further surfactants and further components may be used. In a preferred embodiment of the invention, the nonionic surfactants (I) are used in combination with different nonionic surfactants (II) and/or anionic surfactants (III).

Alk(en)yl polyglucosides (I)

The nonionic surfactants (I) are alk(en)yl polyglucosides of the general formula (I)

R¹—O—(R²)ₚ (I).

In formula (I), R¹ is a linear or branched, saturated or unsaturated aliphatic hydrocarbyl radical having 8 to 18, preferably 8 to 16 and more preferably 8 to 14 carbon atoms. R² is a sugar unit having 5 or 6 carbon atoms, i.e. radicals derived from pentoses and hexoses, and p is a number from 1 to 5.

Examples of hexoses include allose, altrose, glucose, mannose, gulose, idose, galactose or talose; examples of pentoses include ribose, arabinose, xylose or lyxose. Preference is given to glucose or xylose, particular preference to glucose.

The index p in the formula (II) is a number from 1 to 5, and the index denotes the degree of polymerization. It will be apparent to the person skilled in the art that p is a mean value over various individual molecules. p is accordingly a rational number. Preferably, the index p is 1 to 2.

In a preferred embodiment of the invention, the R¹ radicals are linear alkyl and/or alkenyl radicals having 8 to 18, preferably 8 to 16 and more preferably 8 to 14 carbon atoms.

The surfactants of the general formula (II) can be prepared in a manner known in principle by acid-catalyzed reaction of appropriate alcohols R⁴OH with sugars, with removal of the water of reaction. The preparation is known in principle to those skilled in the art. Illustrative descriptions can be found, inter alia, in U.S. Pat. No. 3,547,828 or U.S. Pat. No. 5,898,070.

In a preferred embodiment, the surfactants (II) can be prepared using fatty alcohols, i.e. alcohols obtained proceeding from natural fats or oils. These frequently comprise a mixture of various alcohols, and the surfactants (I) are accordingly a mixture of surfactants having various R¹ radicals.

One embodiment involves alk(en)yl polyglucosides in which the R¹ radicals derive from coconut oil. In this case, n-dodecyl and n-tetradecyl radicals are the main components; in addition, octyl, decyl, hexadecyl and oleyl radicals are also present in smaller amounts.

### Nonionic Surfactants (II)

As well as the nonionic surfactants (I), it is optionally possible also to use different nonionic surfactants (II) for the method of the invention.

The nonionic surfactants (II) are alk(en)yl polyalkoxylates of the general formula (II)

R³—(OCR⁴R⁵CR⁶R⁷)ₓ—(OCH₂CHR⁸)_{y}—(OCH₂CH₂)_{z}—OH (II).

R³ is a branched or linear, saturated or unsaturated aliphatic hydrocarbyl radical having 8 to 22 carbon atoms, preferably 8 to 18 carbon atoms, more preferably 8 to 14 carbon atoms.

Examples of such R³ radicals include linear alkyl radicals such as, more particularly, n-octyl, n-nonyl, n-decyl, n-undecyl, n-dodecyl, n-tetradecyl, n-hexadecyl, n-octadecyl, n-eicosyl or n-docosyl radicals. The surfactants may also comprise mixtures of various R¹ radicals. Particular mention should be made here of mixtures which derive from the use of natural fatty alcohols as starting material for the surfactants (I). For example, this may involve a mixture of n-dodecyl and n-tetradecyl radicals. Further examples of R¹ radicals include branched alkyl radicals such as 2-ethylhexyl, 2-propylheptyl, 2-butyloctyl, 2-pentylnonyl, 2-hexyldecyl radicals, and radicals derived from oxo alcohols, such as i-tridecyl radicals.

In a preferred embodiment, R³ is a branched C₁₀-alkyl radical of the formula C₅H₁₁—CH(C₃H₇)—CH₂—, where at least 70 mol % of the pentyl radicals C₅H₁₁— are an n-C₅H₁₁-radical. The substituent in the 2 position, the propyl radical C₃H₇—, may be an n-C₃H₇-radical or an i-C₃H₇— radical. Preference is given to an n-C₃H₇— radical. The pentyl radicals that are not n-pentyl radicals are preferably branched 1-alkyl radicals, preferably a 2-methyl-1-butyl radical C₂H₅CH(CH₃)CH₂— and/or a 3-methyl-1-butyl radical CH₃CH(CH₃)CH₂CH₂—.

In one embodiment of the invention, 70 to 99 mol % of the C₅H₁₁— radicals are n-C₅H₁₁-radicals, and 1 to 30 mol % of the C₅H₁₁— radicals are C₂H₅CH(CH₃)CH₂— radicals and/or CH₃CH(CH₃)CH₂CH₂— radicals.

In a further embodiment of the invention, R³ is a 2-propyl-n-heptyl radical H₃CCH₂CH₂CH₂CH₂CH(n-C₃H₇)CH₂—.

In a further preferred embodiment, R³ is a 2-ethylhexyl radical.

In a further preferred embodiment, R³ is a linear, saturated hydrocarbyl radical having 12 to 14 carbon atoms, especially a mixture comprising n-dodecyl and n-tetradecyl radicals.

In the formula (II), the R⁴, R⁵, R⁶ and R⁷ radicals are also each independently H or a linear or branched alkyl radical having 1 to 8 carbon atoms, for example methyl, ethyl or propyl radicals, with the proviso that the sum total of the carbon atoms of the R⁴+R⁵+R⁶+R⁷ radicals is 2 to 8, preferably 2 or 3 and more preferably 2. In one embodiment of the invention, the sum total of R⁴+R⁵+R⁶+R⁷=2, where, in at least 70 mol %, preferably at least 80 mol % and more preferably at least 95 mol % of the —OCR⁴R⁵CR⁶R⁷— units, R⁴, R⁵ and R⁶ are each H and R⁶ is ethyl. Preferably, —OCR⁴R⁵CR⁶R⁷— is thus a butoxy group, more preferably a butoxy group which derives essentially from 1,2-butene oxide.

R⁸ is methyl, and so —OCH₂CHR⁸— is a propoxy group and —OCH₂CH₂— is an ethoxy group.

The index x is a number from 0 to 5, preferably 0, the index y is a number from 1 to 15, preferably 1 to 9, for example 2 to 8, and the index z is a number from 1 to 30, preferably 2 to 20, more preferably 5 to 18, for example 8 to 16, where the sum total of x+y+z is 5 to 35, preferably 8 to 29, for example 10 to 25.

The indices x, y and z are also selected with the proviso that z≧(x+y), preferably z>(x+y) and more preferably z≧2(x+y). Thus, there should not be fewer ethoxy groups than—if present—alkoxy groups and propoxy groups together.

It will be apparent to the person skilled in the art in the field of polyalkoxylates that alkoxylation gives rise to a certain distribution of chain lengths, and that x, y and z are mean values over all the molecules. x, y and z are accordingly not natural numbers but rational numbers. A distribution of chain lengths can be described in a manner known in principle by what is called the polydispersity D. D=M_{w}/Mₙ is the ratio of the weight-average molar mass and the number-average molar mass. The polydispersity can be determined by methods known to those skilled in the art, for example by means of gel permeation chromatography.

It will also be apparent to the person skilled in the art that the orientation of the propoxy and/or butoxy groups, according to the reaction conditions, may be —OCR⁴R⁵CR⁶R⁷— or —OCH₂CHR⁸—, or else —OCR⁷R⁶CR⁵R⁴— or —OCHR⁸CH₂—. The representation in formula (II) is not supposed to make any statement with regard to the orientation of the alkoxy units.

In the above formula (I), the —OCR⁴R⁵CR⁶R⁷—, —OCH₂CHR⁸— and —OCH₂CH₂— radicals are in the sequence specified in formula (II). The transition between the blocks may be abrupt or continuous. The person skilled in the art will be aware that small residues of alkylene oxides may remain in the course of an alkoxylation. After addition of the next alkylene oxide, these can then be polymerized into the second block.

The surfactants (II) are prepared by alkoxylation of branched, aliphatic alcohols R³OH with—if present—alkylene oxides having 4 to 10 carbon atoms, preferably butylene oxide, propylene oxide and ethylene oxide, where the alkylene oxides are employed in the sequence mentioned.

If butylene oxide is used, it is possible in principle to use all the isomers, 1,2-butene oxide, 2,3-butene oxide or isobutene oxide. Preference is given to 1,2-butene oxide. In an advantageous manner, it is also possible to use technical mixtures comprising, as a main constituent, 1,2-butene oxide and additionally further butene oxide isomers. More particularly, it is possible to use mixtures comprising at least 70 mol %, preferably at least 80 mol % and more preferably at least 95 mol % of 1,2-butene oxide.

Suitable alcohols R³OH are known to those skilled in the art and are commercially available. Linear alcohols may, for example, be fatty alcohols or mixtures of various fatty alcohols. Linear alcohols can also be prepared by oligomerization of ethylene and subsequent functionalization (e.g. Ziegler process). For synthesis of surfactants having branched hydrocarbyl radicals, it is possible to use oxo alcohols or Guerbet alcohols.

For synthesis of preferred surfactants having C₅H₁₁—CH(C₃H₇)—CH₂— as R³ radicals, the alcohol C₅H₁₁CH(C₃H₇)CH₂OH is used, where C₅H₁₁— and C₃H₇— are each as defined above, including the preferred definition given above.

Alcohols C₅H₁₁CH(C₃H₇)CH₂OH are obtainable by methods known in principle to those skilled in the art.

They can be prepared by aldol condensation of valeraldehyde and subsequent hydrogenation. The preparation of valeraldehyde and the corresponding isomers is effected by hydroformylation of butene, as described, for example, in U.S. Pat. No. 4,287,370; Beilstein E IV 1, 32 68, Ullmanns Encyclopedia of Industrial Chemistry, 5th edition, volume A1, pages 323 and 328 ff. The subsequent aldol condensation is described, for example, in U.S. Pat. No. 5,434,313 and Rompp, Chemie Lexikon, 9th edition, under “Aldol-Addition”, page 91. The hydrogenation of the aldol condensation product follows general hydrogenation conditions.

Alcohols C₅H₁₁CH(C₃H₇)CH₂OH can also be prepared from 1-pentanol by means of the Guerbet reaction. For this purpose, it is also possible to use technical 1-pentanols, which generally comprise certain amounts of methyl-1-butanols. In the Guerbet reaction, the 1-pentanols are converted in the presence of KOH at elevated temperatures; see, for example, Marcel Guerbet, C. R. Acad Sci Paris 128, 511, 1002 (1899), Römpp, Chemie Lexikon, 9th edition, Georg Thieme Verlag Stuttgart, and the literature cited therein, and also Tetrahedron, vol. 23, pages 1723 to 1733.

In one embodiment of the invention, the alcohol used is R³OH C₅H₁₁CH(C₃H₇)CH₂OH where, for 70 to 99 mol % of the alcohol, is defined as n-C₅H₁₁— and, for 1 to 30 percent by weight of the alcohol. C₅H₁₁— is defined as C₂H₅CH(CH₃)CH₂— and/or CH₃CH(CH₃)CH₂CH₂—. Such alcohols are commercially available.

In a further embodiment of the invention. R³OH is 2-propyl-1-heptanol H₃CCH₂CH₂CH₂CH₂CH(n-C₃H₇)CH₂OH.

The performance of the abovementioned alkoxylation is known in principle to those skilled in the art. It is likewise known to those skilled in the art that the reaction conditions, especially the selection of the catalyst, can influence the molecular weight distribution of the alkoxylates.

For example, the surfactants of the general formula (II) can be prepared by base-catalyzed alkoxylation. In this case, the alcohol R¹OH can be admixed in a pressure reactor with alkali metal hydroxides, preferably potassium hydroxide, sodium hydroxide, with alkaline earth metal hydroxides, or with alkali metal alkoxides, for example sodium methoxide. Water and/or methanol still present in the mixture can be drawn off by means of reduced pressure (for example <100 mbar) and/or increasing the temperature (30 to 150° C.). Thereafter, the alcohol is present partly in the form of the corresponding alkoxide. This is followed by inertization with inert gas (for example nitrogen) and stepwise addition of the alkylene oxide(s) at temperatures of 90 to 180° C. up to a maximum pressure of 10 bar. In one embodiment, the alkylene oxide is metered in initially at 120° C. In the course of the reaction, the heat of reaction released causes the temperature to rise up to 170° C. The wait time between injection of the various alkylene oxides can be shortened in one embodiment, such that the alkylene oxide injected last has not yet reacted to completion and the newly injected alkylene oxide results in formation of mixed blocks with small amounts of the previously added alkylene oxide. If present, butylene oxide can be added first at a temperature in the range from 125 to 145° C., then the propylene oxide at a temperature in the range from 125 to 145° C., and subsequently the ethylene oxide at a temperature in the range from 120 to 155° C. In the case of absence of butyleneoxy units in the molecule, first propylene oxide and then ethylene oxide is metered in. At the end of the reaction, the catalyst can, for example, be neutralized by adding acid (for example acetic acid, citric acid or phosphoric acid) and be filtered off if required.

The alkoxylation of the alcohols R³OH can of course also be undertaken by means of other methods, for example by acid-catalyzed alkoxylation. In addition, it is possible to use, for example, double hydroxide clays, as described in DE 4325237 A1, or it is possible to use double metal cyanide catalysts (DMC catalysts). Suitable DMC catalysts are disclosed, for example in DE 10243361 A1, especially in paragraphs [0029] to [0041] and the literature cited therein. For example, it is possible to use catalysts of the Zn—Co type. To perform the reaction, the alcohol R¹OH can be admixed with the catalyst, and the mixture dewatered as described above and reacted with the alkylene oxides as described. Typically not more than 1000 ppm of catalyst based on the mixture are used, and the catalyst can remain in the product owing to this small amount. The amount of catalyst may generally be less than 1000 ppm, for example 250 ppm or 100 ppm or less.

### Nonionic Surfactants (III)

As well as the nonionic surfactants (I), it is additionally optionally possible to use anionic surfactants (III) other than the surfactants (I) for the method of the invention. The anionic surfactants (III) are alkylphenol polyalkoxylates of the general formula (III)

R⁹—C₆H₄—O—(OCR⁴R⁶CR⁶R⁷)ᵤ—(OCH₂CHR⁸)ᵥ—(OCH₂CH₂)_{w}—OH (III).

In the formula (III), R⁹ is a linear or branched alkyl radical having 8 to 12 carbon atoms.

The —C₆H₄— group, in a manner known in principle, is a phenylene group, preferably a 1,4-phenylene group.

In the formula (III), R⁴, R⁵, R⁶, R⁷ and R⁸ are each as defined above and have the areas of preference specified.

The index u is a number from 0 to 5, preferably 0, the index v is a number from 0 to 15, preferably 0, and the index w is a number from 5 to 30, preferably 6 to 20, more preferably 8 to 18, where the sum total of u+v+w is 5 to 35, preferably 6 to 29, for example 8 to 20.

The indices u, v and w are also selected with the proviso that u≧(v+w), preferably u>(v+w) and more preferably u≧2(v+w). Thus, there should not be fewer ethoxy groups than—if present—alkoxy groups and propoxy groups together. The values u, v and w are of course mean values. We refer in this regard to the description for surfactant (I).

The —OCR⁴R⁵CR⁶R⁷—, —OCH₂CHR⁸— and —OCH₂CH₂— radicals are arranged in the sequence specified in formula (III).

### Further Co-Surfactants

As well as the nonionic surfactants of the general formula (I) and optionally the surfactants (II) and/or (III), it is optionally possible to use further surfactants. Examples of additional co-surfactants include anionic surfactants such as paraffinsulfonates or olefinsulfonates (alpha-olefinsulfonates or internal olefinsulfonates), nonionic surfactants such as alkyl ethoxylates other than the surfactants (II) or polyalkoxylates formed from propylene oxide and ethylene oxide, or surfactants which are permanently cationic (alkylamines quaternized with alkyl or hydroxyalkyl groups, for example N,N,N-trimethyldodecylammonium chloride) or cationic under the deposit conditions (e.g. alkylamine alkoxylates, which are cationic at pH 3).

### Formulation (F) of the Surfactants

For the method of the invention, the surfactants (I), optionally further surfactants, especially surfactants (II) and (III), and optionally further components, can be used as such; for example, said surfactants and/or further components can be dissolved directly in liquid or supercritical CO₂.

In a preferred embodiment of the invention, these components, however, are used in the form of a suitable aqueous formulation (F). This aqueous formulation (F) can be metered and injected into liquid or supercritical CO₂, or the aqueous formulation can be injected into the formation as such or else after further dilution.

Said formulation (F) may especially be an aqueous concentrate, which can be produced on site or else at a separate chemical production site. The total concentration of all the surfactants in such an aqueous concentrate is selected by the person skilled in the art according to the desired properties. It may be 20 to 90% by weight based on all the components of the concentrate. Prior to injection, the concentrate may be diluted to the desired use concentration with liquid or supercritical CO₂ and/or further aqueous solvents, as will be outlined further down.

In addition to water, the formulations (F) may optionally also comprise water-miscible or at least water-dispersible organic solvents. Such additives serve especially to stabilize the surfactant solution during storage or transport to the oil field. The amount of such additional solvents should, however, generally not exceed 50% by weight, preferably 20% by weight. Examples of water-miscible solvents include especially alcohols such as methanol, ethanol and propanol, butanol, sec-butanol, methoxypropanol, pentanol, ethylene glycol, diethylene glycol, propylene glycol, methyl propylene glycol, dipropylene glycol, methyl dipropylene glycol, butyl ethylene glycol, butyl diethylene glycol or butyl triethylene glycol. In a particularly advantageous embodiment of the invention, exclusively water is used for formulation.

As well as the surfactants, the aqueous formulations (F), especially the aqueous concentrates, may also comprise further components, for example scale inhibitors, biocides, free-radical scavengers, stabilizers, tracers or pour point depressants. Suitable pour point depressants are especially the abovementioned alcohols.

### Method for Mineral Oil Production by Means of CO₂ Flooding

For the method of the invention for CO₂ flooding, at least one injection well and at least one separate production well are sunk into a mineral oil deposit. In general, a deposit is provided with several injection wells and with several production wells.

The mineral oil deposits in which the method of the invention is employed can in principle be any desired deposits, for example formations comprising carbonate rocks, or formations comprising sandstone. The mineral oil deposits comprise mineral oil and saline deposit water, with intercalation of mineral oil, deposit water and possibly natural gas in pores, clefts or interstices in the formation.

The deposit temperature is generally at least 10° C., especially 15° C. to 140° C., preferably 31° C. to 120° C., more preferably 40° C. to 120° C., even more preferably 50° C. to 100° C. and, for example, 60° C. to 90° C.

It will be apparent to the person skilled in the art that the deposit temperature may have a certain distribution about a mean value, with significant deviations generally caused less frequently by natural circumstances than by human interventions in particular, for example by prolonged water flooding or prolonged steam flooding.

The total salinity of the deposit water may be up to 350 000 ppm, for example 20 000 ppm to 350 000 ppm. The method can preferably be employed in deposits having a total salinity of 30 000 ppm to 250 000 ppm, preferably 35 000 ppm to 200 000 ppm, more preferably 35 000 ppm to 180 000 ppm, for example 120 000 ppm to 170 000 ppm.

The salts of the deposit may especially be alkali metal salts and alkaline earth metal salts. Examples of typical cations include Na⁺, K⁺, Mg²⁺ or Ca²⁺, and examples of typical anions include chloride, bromide, hydrogencarbonate, sulfate or borate. In general, at least one or more than one alkali metal ions(s) is present in the deposit water, especially at least Na⁺. In addition, it is also possible for alkaline earth metal ions to be present, in which case the weight ratio of alkali metal ions/alkaline earth metal ions is generally ≧5, preferably ≧8. Anions present are generally at least one or more than one halide ion, especially at least Cl⁻. In general, the amount of Cl⁻ is at least 50% by weight, preferably at least 80% by weight, based on the sum total of all the anions.

Liquid or supercritical CO₂ and at least one nonionic surfactant (I) or a surfactant mixture comprising at least one nonionic surfactant (I) are injected into the mineral oil formation through the at least one injection well, and mineral oil is withdrawn from the deposit through at least one production well, the at least one surfactant (I) or the surfactant mixture comprising at least one surfactant (I) having been dissolved in liquid or supercritical CO₂ and being injected and/or having been dissolved in an aqueous medium and being injected.

The term “mineral oil” in this context of course does not just mean single-phase oil; instead, the term also encompasses the usual crude oil-water emulsions. In addition—according to the stage of the method—injected CO₂ is also produced through the production well.

When CO₂ is pumped into a deposit, the pressure and temperature decide the physical state of the CO₂. The phase diagram of CO₂ is well known to those skilled in the art. CO₂ can be liquefied within the temperature range from −56.6° C. to 30.98° C. with employment of a pressure of at least 5.2 bar. At less than 5.2 bar, according to the temperature, only solid or gaseous CO₂ exists. The critical point of CO₂ is at 30.98° C. and 73.75 bar. At pressures and temperatures above these values, CO₂ is supercritical, meaning that the liquid-gaseous phase boundary vanishes and the CO₂ is nearly as dense as a liquid but still has a very low viscosity similar to that of a gas.

For production of liquid or supercritical CO₂, gaseous CO₂ can be compressed on site, for example proceeding from produced CO₂, or CO₂ can be supplied already in the compressed state. The minimum pressure needed for injection is calculated from the deposit temperature and is selected such that the CO₂ injected is in the liquid or supercritical state at the respective deposit temperature. It has been found to be useful, for CO₂ flooding, to adjust the density of the CO₂ under deposit conditions to 0.65 g/mL to 0.95 g/mL, preferably 0.70 g/mL to 0.90 g/mL. The density of the CO₂ as a function of pressure and temperature can be found in relevant tables.

The at least one nonionic surfactant (I) or the surfactant mixture comprising at least one nonionic surfactant (I) can be injected by means of various techniques.

In a first embodiment (A) of the method of the invention, the surfactants or surfactant mixtures used and optionally further components are dissolved in liquid or supercritical CO₂, and the CO₂ solution is injected into the underground mineral oil deposit. Processes of this kind are also referred to as a surfactant-in-gas process (SinG).

In embodiment (A), the surfactant (I) or the surfactant mixture comprising surfactants (I) can be mixed as such with the CO₂, dissolved and injected, or it is possible to use a suitable formulation of the surfactants. More particularly, the above-described formulations (F) may be used and metered into a stream of liquid or supercritical CO₂ and mixed with the stream especially in the form of concentrates having a surfactant content of 20 to 90% by weight based on the sum total of all the components.

The amount of the surfactants or of the formulation (F) or of the concentrate is such that the amount of all the surfactants together is 0.02 to 2% by weight, preferably 0.02 to 0.5% by weight, based on the sum total of all the components of the solution of surfactants in liquid or supercritical CO₂.

After entering the formation, the CO₂ flows in the direction of the production well(s), and in doing so mobilizes oil by the mechanisms outlined at the outset. If the liquid or supercritical CO₂ with the dissolved surfactants encounters deposit water after being injected into the formation, CO₂-in-water emulsions form, which are stabilized by the surfactant(s) (I) or mixtures comprising surfactants (I), and optionally further surfactants.

Since there is no longer any phase boundary between gaseous and liquid phase in the case of supercritical CO₂, CO₂-in-water emulsions of this kind are occasionally also referred to in the literature as CO₂-in-water foams, and the term “CO₂-in-water dispersions” can also be found in the literature. However, the term “CO₂-in-water emulsion” is to be used uniformly hereinafter.

The CO₂-in-water emulsions have a much higher viscosity than CO₂ itself, and hence the difference between the viscosity of the CO₂-in-water emulsion and the mineral oil is smaller, generally much smaller, than the difference between the viscosity of liquid or supercritical CO₂ and the mineral oil. The CO₂-in-water emulsions too flow in the direction of the production well(s). Liquid or supercritical CO₂ bound within the emulsion, when it encounters oil, can also mobilize the oil in the same manner as already outlined. Advantageously, the surfactants (I) and optionally further surfactants also lower the interfacial tension between oil and CO₂, and hence also facilitate the miscibility of these two phases.

The injected liquid or supercritical CO₂, by its nature, flows first of all into the more highly permeable zones. As soon as more viscous CO₂-in-water emulsions form therein when water is encountered, the flow through the permeable zones is made much more difficult, such that further CO₂ pumped in seeks a path through low-permeability zones and can mobilize previously unattainable oil. This enhances the oil production rate. Should the capillary pressure in the very low-permeability zones become too high, the CO₂-in-water aggregate may collapse. This is not disadvantageous, however, since the very low-permeability zones would barely have been accessible to the CO₂ in the case of flooding with CO₂ alone or in the water-alternating-gas process.

In a second embodiment (B) of the method of the invention, water or saline water, for example seawater or produced deposit water, is firstly injected through the injection well into the deposit.

Subsequently, analogously to embodiment (A), a solution of the surfactants or surfactant mixtures used, and optionally further components, in liquid or supercritical CO₂ is injected.

The amount of the surfactants or of the formulation (F) or of the concentrate is such that the amount of all the surfactants together is 0.02 to 2% by weight, preferably 0.02 to 0.5% by weight, based on the sum total of all the components of the solution of surfactants in liquid or supercritical CO₂.

The sequence of these two method steps can be repeated once or more than once. At the points of contact between the water phase and the CO₂ phase, CO₂-in-water emulsions form. Processes of this kind are also referred to as a water-alternating-surfactant-in-gas process (WAGS).

In a third embodiment (C) of the method of the invention, an aqueous formulation of the surfactants (I) or surfactant mixtures comprising surfactants (I) is injected into the formation and, separately, liquid or supercritical CO₂.

For the injection, more particularly, the above-outlined concentrates of the formulation (F) can be mixed with water or saline water and injected into the formation.

The amount of the surfactants is such that the concentration of all the surfactants together is 0.02 to 2% by weight, preferably 0.02 to 0.5% by weight, based on the sum total of all the components of the aqueous solution injected.

Thereafter, liquid or supercritical CO₂ is injected into the deposit. The sequence of these two method steps can be repeated once or more than once. At the points of contact between the water phase and the CO₂ phase, CO₂-in-water emulsions form. Processes of this kind are also referred to as a surfactant-in-water-alternating-gas process (SAG).

To further improve mobility control in embodiments (B) and (C), the water phase can be thickened with a water-soluble, thickening polymer, for example polyacrylamide, partly hydrolyzed polyacrylamide, acrylamide-containing copolymers, acrylamide-containing copolymers containing sulfonate groups, or biopolymers such as xanthan.

It is preferable to inject the surfactants (I) and optionally further surfactants and components dissolved in liquid CO₂ or supercritical CO₂ (embodiments (A) and (B)). These variants have the advantage that the surfactant (I) and optionally further surfactants and components are present when the liquid or supercritical CO₂, after being injected, encounters formation water in the formation, such that the rapid formation of CO₂-in-water emulsions is enabled.

If the surfactant, as per embodiment (C), is injected separately from the CO₂ by means of an aqueous solution, water and CO₂ can also (partly) take different flow paths in the formation because of their different properties. There is thus the risk that a portion of the surfactant will remain unutilized.

The person skilled in the art is aware of details of the industrial performance of “CO₂ flooding”, “water-alternating-gas flooding”, and of the SinG, WAGS and SAG processes, and will employ an appropriate technique according to the type of deposit.

It will be appreciated that still further embodiments are possible for the method of the invention. For example, the CO₂-in-water emulsions outlined can be formed even prior to injection from liquid or supercritical CO₂, surfactants (I) and optionally further surfactants, and the CO₂-in-water emulsions can be injected.

The main effect of the surfactants (I) used in accordance with the invention lies in the stabilization of the CO₂-water interface and hence in CO₂-in-water emulsions of prolonged stability. The surfactants (I) stabilize the CO₂-in-water emulsions better than surfactants according to the prior art. The CO₂-in-water emulsions remain stable for much longer than is the case for known surfactants.

### Selection of the Surfactants

The person skilled in the art will select at least one surfactant (I) for performance of the method of the invention according to the type of deposit. Optionally, the surfactants (I) can be used in a mixture with further surfactants (I), at least one surfactant (II) and/or at least one surfactant (III). Optionally, further surfactants and further components may be used.

The type of surfactant (I) and of any further surfactants to be used is guided by the deposit conditions, more particularly by the deposit temperature and the salinity of the deposit water. The person skilled in the art will make a suitable selection according to the deposit conditions.

In general, the cloud point of the surfactant used, or of the surfactant mixture used, under deposit conditions should be at least 1° C., preferably at least 3° C., above the deposit temperature. If the deposit has a distribution of deposit temperatures, what is meant thereby is the highest deposit temperature in the region through which the liquid or supercritical CO₂ or the CO₂-in-water emulsion flows.

The cloud point of a nonionic surfactant is that temperature at which the solution becomes cloudy. The cause of this is that the surfactant is dehydrated with rising temperature and hence becomes insoluble. Thus, the solution separates into a cloudy surfactant-rich and a clear surfactant-poor phase. This phase behavior is encountered not just in the case of nonionic surfactants, but also in the case of surfactants having a nonionic, hydrophilic molecular moiety, for example a polyalkoxy group and an anionic group. Cloud points are also measurable for the anionic surfactants (III) of this invention.

The cloud point is measured by gradually heating a clear aqueous solution of the surfactant in water. The cloud point of a surfactant depends on the concentration of the surfactant and the salt content of the aqueous solution. A specific method of measurement for the cloud point is included in the examples section of this application.

The term “under deposit conditions” in the above definition means that the cloud point of the surfactant (I) to be used or of the surfactant mixture comprising surfactant (I) is determined in deposit water at the concentration envisaged for injection, i.e. the concentration of the surfactant in the aqueous medium to be injected or the concentration in the liquid or supercritical CO₂ to be injected.

The cloud point of the optionally used surfactants of the formula (II) R³—(OCR⁴R⁵CR⁶R⁷)ₓ—(OCH₂CHR⁸)_{y}—(OCH₂CH₂)_{z}—OH or of the optionally used surfactants (III) can be matched efficiently to the conditions in the deposit via the type of alkoxylation scheme.

The greater the number x of alkoxy groups —OCR⁴R⁵CR⁶R⁷— and the greater the number y of propoxy groups —OCH₂CHR⁸, the lower the cloud point, and the higher the number z of ethoxy groups the higher the cloud point.

Because of the contact with CO₂, the aqueous phases in CO₂ flooding have a pH of typically 2 to 4. It has been found that, surprisingly, the alk(en)yl polyglucosides (I) are nevertheless sufficiently stable under the acidic conditions of CO₂ flooding, even though they could be hydrolysis-sensitive because of their acetal structure.

In a further embodiment of the method of the invention, a mixture of at least one surfactant (I) and at least one surfactant (II) is used.

The weight ratio of surfactants of the formula (I) to (II) is selected by the person skilled in the art according to the requirements. In general, the weight ratio (I)/(II) is 19:1 to 1:19, preferably 4:1 to 1:9, more preferably 2:1 to 1:9 and, for example, 1:1 to 1:4. Preferred total amounts for the amount of all surfactants have already been mentioned.

A mixture of the surfactants (I) and (II) can be injected into the deposit as formulated above, either as an aqueous formulation or else dissolved in liquid or supercritical CO₂.

The mixture of surfactants (I) and (II) still has very good solubility in water even at high salinity, and the solubility in CO₂ is also good.

It has also been found that, surprisingly, a mixture of surfactants (I) with surfactants (II) has synergistic effects with regard to emulsifiability. The mixture of (I) and (II) binds more saline water in the CO₂-in-water emulsion than would have been expected on the basis of the measurements for the surfactants (I) alone and (II) alone.

The adsorption of the mixture both on carbonate rock and on sandstone is low.

In a further embodiment of the method of the invention, a mixture of at least one surfactant (I) and at least one surfactant (III) is used.

The weight ratio of surfactants of the formula (I) to (III) is selected by the person skilled in the art according to the requirements. In general, the weight ratio (I)/(III) is 19:1 to 1:19, preferably 4:1 to 1:9, more preferably 2:1 to 1:9 and, for example, 1:1 to 1:4. Preferred total amounts have already been mentioned.

A mixture of the surfactants (I) and (III) can be formulated as above and is preferably injected into the deposit as an aqueous formulation, followed by the injection of liquid or supercritical CO₂ (embodiment (C)).

The mixture of surfactants (I) and (III) still has very good solubility in water even at high salinity, and the solubility in CO₂ is also good.

It has also been found that, surprisingly, a mixture of surfactants (I) with surfactants (III) has synergistic effects with regard to emulsifiability. The mixture of (I) and (III) binds more saline water in the CO₂-in-water emulsion than would have been expected on the basis of the measurements for the surfactants (I) alone and (III) alone.

The adsorption of the mixture on sandstone is low.

The examples which follow are intended to illustrate the invention in detail:

### Part I: Surfactants Used

### I-1: Surfactants (I)

A commercially available C_{8/14}-alkyl polyglucoside (Glucopon® 425 N/NH) based on coconut oil was used. The alkyl polyglucoside comprises linear saturated alkyl radicals having 8, 10, 12 and 14 carbon atoms.

I-2: Synthesis of alk(en)yl polyalkoxylates (Surfactants (II))

For the synthesis, the alcohols below were used as starting materials.

| Alcohol | Description |
|---|---|
| 2-EH | 2-ethylhexanol (2-ethylhexan-1-ol) |
| 2-PH | Isomer mixture of branched C₁₀ alcohols, comprising about |
| | 87% by weight of 2-propyl-1-heptanol, about 11% by weight of |
| | 2-propyl-4-methyl-1-hexanol, and small amounts of further |
| | isomers |

### General Procedure:

In a 2 l autoclave, the alcohol to be alkoxylated (1.0 eq) is optionally admixed with an aqueous KOH solution comprising 50% by weight of KOH. The amount of KOH is 0.2% by weight of the product to be prepared. The mixture is dewatered while stirring at 100-120° C. and 20 mbar for 2 h. This is followed by purging three times with N₂, establishment of a supply pressure of approx. 1.3 bar of N₂ and an increase in the temperature to 130° C. The alkylene oxides are subsequently metered in successively in the amount desired in each case, such that the temperature remains between 135 and 145° C. This is followed by stirring at 135 to 145° C. for a further 1 h, purging with N₂, cooling to 80° C. and emptying of the reactor. The basic crude product is neutralized with the aid of acetic acid. Alternatively, neutralization can also be effected with commercial magnesium silicates, which are subsequently filtered off. The light-colored product is characterized with the aid of a 1H NMR spectrum in CDCl₃, gel permeation chromatography and an OH number determination, and the yield is determined.

Using the general procedure, various nonionic surfactants for the performance tests were synthesized. The formula of each of the synthesized products is given in the tables which follow.

### I-3 Surfactants (III)

For the experiments, 4-octylphenol-10 EO and 4-octylphenol-16 EO were used. Both surfactants are commercially available.

### Part II: Performance Tests

### II-I: Measurement of Cloud Point in Water

In a first test series, the cloud point of the surfactants or mixtures of various surfactants was determined.

### General Measurement Procedure:

50 mL of the respective aqueous surfactant solution are heated in a test tube over a Bunsen burner. In the course of this, the solution is stirred with a spatula. The temperature of the solution is determined by means of a thermometer immersed into the solution. After the appearance of cloudiness, the Bunsen burner is removed, such that the solution can cool down gradually, and stirring is continued until the solution is clear again. The cloud point is the changeover from cloudy to clear, and it generally takes place within a temperature range of 1° C.

### Procedure for the Measurements

The measurements were conducted with aqueous surfactant solutions both in fresh water and in salt water of varying salt concentration. The salt water used was aqueous solutions having NaCl and CaCl₂ present in a ratio of 9:1 (based on weight). The salinity ranges from 0 to 250 000 ppm TDS (total dissolved salt).

The respective salinity and the type and amount of the surfactants used in each case, and the cloud points measured, are summarized in tables 1a to 1c.

Table 1 shows the influence of the structure of the surfactants (I) used in accordance with the invention and the salinity on the cloud points measured.

TABLE 1
Cloud points of various surfactants in water (PO = propoxy, EO = ethoxy)

| | | | Conc. | | | |
|---|---|---|---|---|---|---|
| | | | of the | | | |
| | Surfactant | | surfactant | Salinity | Cloud point | |
| Ex. | Type | Formula | [% by wt.] | [ppm TDS] | [° C.] | Comments |
| 1 | Surfactant I | C_{8/14}-alkyl polyglucoside | 0.05 | 160000 | >100 | |
| | | | 0.05 | 200000 | >100 | |
| 2 | Surfactant II | 2-PH-3 PO-9 EO | 0.05 | 160000 | 18 | |
| 3 | Surfactant II | 2-PH-5 PO-15 EO | 0.05 | 160000 | 43 | |
| 4 | Surfactant II | 2-EH-5 PO-9 EO | 0.1 | 160000 | 20 | |
| 5 | Surfactant III | octylphenol-10 EO | 0.05 | 160000 | 28 | Cloud point rises with increasing |
| 6 | Surfactant III | octylphenol-16 EO | 0.05 | 160000 | 58 | ethoxylation level |
| 7 | Surfactants I + | C_{8/14}-alkyl polyglucoside + | 0.1 | 160000 | 56 | |
| | II | 2-PH-5 PO-15 EO (1:1) | | | | |
| 8 | Surfactants I + | C_{8/14}-alkyl polyglucoside + | 0.1 | 160060 | 31 | |
| | II | 2-EH-5 PO-9 EO (1:1) | | | | |
| 9 | Surfactants I + | C_{8/14}-alkyl polyglucoside + | 0.1 | 160000 | 64 | |
| | III | octylphenol-16 EO (1:1) | | | | |

Table 1 shows that the C_{8/14}-alkyl polyglucoside has a cloud point of >100° C. at salinities of 160 000 ppm and 200 000 ppm. The surfactant is therefore quite outstandingly suitable for high-salinity deposits.

II-II Solubility in Supercritical CO₂

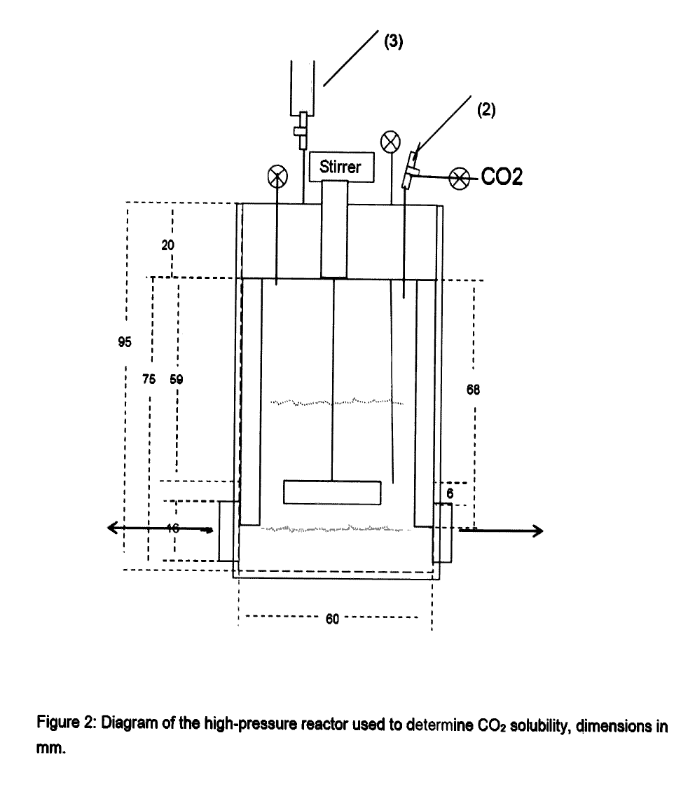

Thereafter, the solubility of the surfactants in supercritical CO₂ was examined. The apparatus used was a 280 mL high-pressure reactor having two sightglasses in the lower region of the reactor. The construction of the apparatus is shown in schematic form in FIG. 2. The reactor comprises a CO₂ inlet (1), a manometer (2), a CO₂ pressure release valve (325 bar), and two sightglasses (4) opposite one another in the lower reactor region. The reactor can be stirred by means of a stirrer.

To determine the solubility, different pressures and temperatures were set. First of all, surfactant was admixed with CO₂ while stirring and the pressure was altered at a particular temperature. If cloudiness set in—as compared with the surfactant-free CO₂ phase under the same conditions—the conditions were noted.

Next, conditions which can frequently be found at an appropriate deposit depth were selected (lithostatic and hydrostatic pressure and deposit temperature as a function of depth). The density of the CO₂ under the conditions selected (175 bar at 40° C. or 300 bar at 65° C.) was about 0.78 to 0.82 g/mL. Surfactant concentrations of 0.1 and 0.5% by weight based on the CO₂ phase were examined.

The results are summarized in Table 2. The solubility was rated as follows:

TABLE 2
Solubility in supercritical CO₂

| Rating | Description |
|---|---|
| very good | no residues on sightglass or turbidity of the solution |
| good | slight residues on sightglass or turbidity of the solution, for |
| | example small discrete streaks |
| moderate | clearly visible residues on sightglass or turbidity of the |
| | solution; streaks over a large area |

| | | Surfactant | | Tem- | |
|---|---|---|---|---|---|
| | | concentra- | Pressure | perature | |
| Ex. | Surfactant | tion [%] | [bar] | [° C.] | Solubility |
| 10 | C_{8/14}-Alkyl | 0.1 | 175 | 40 | moderate |
| | polyglucoside | 0.5 | 175 | 40 | moderate |
| 11 | 2-PH-3 PO-9 EO | 0.1 | 175 | 40 | very good |
| 12 | 2-PH-5 PO-15 EO | 0.1 | 175 | 40 | very good |
| | 2-PH-5 PO-15 EO | 0.5 | 175 | 40 | good |
| 13 | 2-PH-5 PO-15 EO | 0.1 | 300 | 65 | very good |
| 14 | 2-EH-5-PO-9 EO | 0.1 | 175 | 40 | good |
| | 2-EH-5-PO-9 EO | 0.5 | 175 | 40 | moderate |
| 15 | 4-octylphenol-10 EO | 0.1 | 175 | 40 | very good |
| 16 | 4-octylphenol-16 EO | 0.1 | 175 | 40 | very good |
| | | 0.1 | 300 | 65 | very good |

### II-III Emulsifiability

In addition, the ability of various surfactants and surfactant mixtures to stabilize CO₂-in-water emulsions was tested.

The above reactor was utilized. Surfactant was initially charged in the concentrations specified in the tables which follow, and made up to 40 mL with saline water. The saline water was a solution of NaCl and CaCl₂ in water (weight ratio of NaCl CaCl₂=9:1). Tests were conducted at various total salinities. These are specified in each case in the tables which follow.

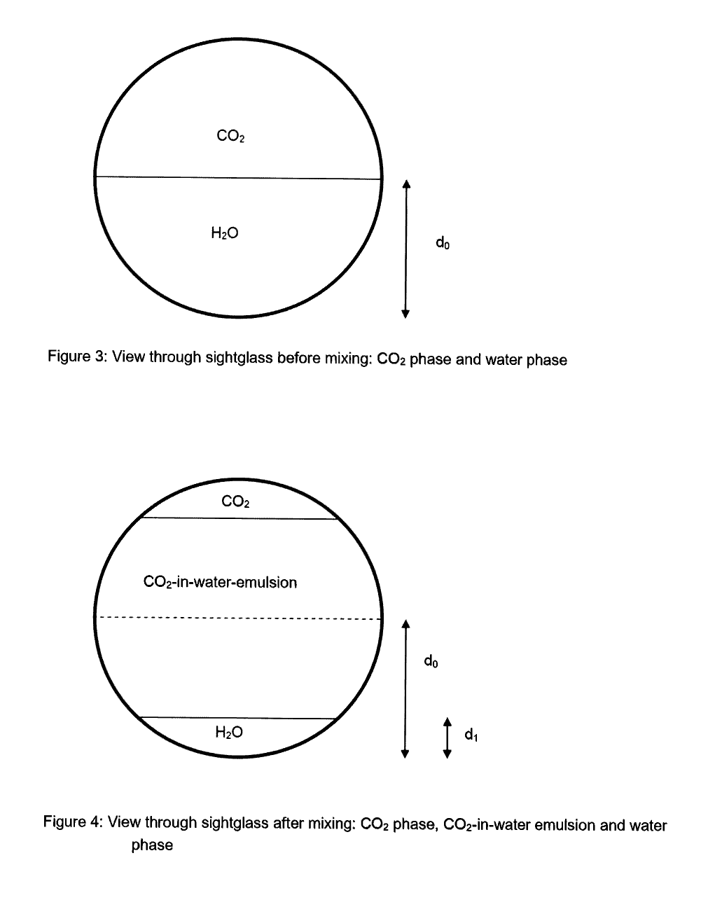

The high-pressure apparatus was filled with the aqueous solution to exactly the middle of the sightglass. The reactor was subsequently made up to 280 mL with supercritical CO₂. The water phase and the CO₂ phase are each clear, and the phase boundary between CO₂ and water is clearly apparent through the sightglass. This is shown in schematic form in FIG. 3a. Subsequently, the mixture is stirred.

The formation of CO₂-in-water emulsions can then be observed through the sightglass. The CO₂-in-water emulsions formed are not clear like the CO₂ phase and the water phase, but cloudy to opaque. According to the degree of conversion of the water phase to the CO₂-in-water emulsion, only the CO₂-in-water emulsion may be visible through the sightglass, or all 3 phases may be visible, namely water, CO₂-in-water emulsion and CO₂. This is shown in schematic form in FIG. 4.

The proportion of water bound in the CO₂-in-water emulsion can be determined by determination of the fill level of the water d₁ in the sightglass compared to the fill level of the water do in the sightglass prior to mixing (middle of the sightglass) by the relationship: proportion [%]=100*(d₀−d₁)/d₀. The proportion of the portion of CO₂ bound in the emulsion that is visible in the glass can be determined in an analogous manner.

After the stirrer has been switched off, it is possible to observe how quickly the CO₂-in-water emulsion breaks down again by observing the fill heights as a function of time through the sightglass.

Table 3 shows the experimental parameters and the proportions of water and CO₂ that are each visible in the sightglass 1 h after the stirrer has been switched off.

TABLE 3
CO₂-in-water emulsions at various salinities. The proportions of bound water and bound CO₂ were determined as described
above by means of the relationship: proportion [%] = 100 * (d₀ − d₁)/d₀.

| | | | | | | | | Amount of water | |
|---|---|---|---|---|---|---|---|---|---|
| | | | | | | | | and CO₂ | |
| | | | | | | | | still bound in the | |
| | | Surfactant | | Cloud | | | Density | emulsion after 1 h | |
| | | concentration | Salinity | point | Pressure | Temperature | of CO₂ | Water | |
| Ex. | Surfactant | [%] | [ppm] | [° C.] | [bar] | [° C.] | [g/ml] | [%] | CO₂ [%] |
| 17 | C_{8/14}-alkyl polyglucoside | 0.05 | 160000 | >100 | 210 | 50 | 0.78 | 22 | 100 |
| C1 | octylphenol-10 EO | 0.05 | 160000 | 28 | 300 | 65 | 0.82 | 0 | 0 |
| C2 | octylphenol-16 EO | 0.05 | 160000 | 58 | 275 | 60 | 0.8 | 0 | 0 |
| C3 | 2-EH-5 PO-9 EO | 0.05 | 160000 | 20 | 300 | 65 | 0.82 | 0 | 0 |
| C4 | 2-PH-3 PO-9 EO | 0.05 | 160000 | 18 | 300 | 65 | 0.82 | 0 | 0 |
| C5 | 2-PH-5 PO-15 EO | 0.05 | 160000 | 43 | 300 | 65 | 0.82 | 0 | 0 |
| C6 | 2-PH-5 PO-15 EO | 0.05 | 160000 | 43 | 210 | 50 | 0.78 | 0 | 0 |
| 18 | C_{8/14}-alkyl polyglucoside + | 0.1 | 160000 | 56 | 210 | 50 | 0.78 | 40 | 100 |
| | 2-PH-5 PO-15 EO (1:1) | | | | | | | | |
| 19 | C_{8/14}-alkyl polyglucoside + | 0.1 | 150000 | 65 | 300 | 62 | 0.8 | 38 | 100 |
| | 2-EH-5 PO-9 EO (1:1) | | | | | | | | |

### Comments on the Experiments Conducted:

In the CO₂-in-water emulsion, water forms the continuous phase and hence functions as a buffer between discrete CO₂ phases. If the CO₂-in-water emulsion loses water, this leads at some point to combination of the discrete CO₂ phases, meaning that the CO₂-in-water emulsion breaks down. Breakdown of the emulsion in the mineral oil formation is highly undesirable, since the emulsion has a much higher viscosity than the supercritical CO₂ (see above) and it is specifically this higher viscosity that is required for avoidance of “fingering”.

It is therefore advantageous when the CO₂-in-water emulsion, for a given amount of CO₂, binds a maximum amount of water in the emulsion, in order to have a stable emulsion for as long as possible. The more water is bound, the more water the emulsion can lose without emulsion breakdown, and, correspondingly, the longer it takes for the emulsion to break down.

Comparative experiments C1 to C6 show the importance of the cloud point for the formation of the CO₂-in-water emulsions. If the cloud point of the surfactant in water at the particular salinity is below the measurement temperature, no CO₂-in-water emulsions are formed.

The surfactant (I) alone binds 22% water. These values can be distinctly improved by the addition of surfactants (II).

1.-29. (canceled)

30. A method for mineral oil production by means of CO₂ flooding, in which liquid or supercritical CO₂ and at least one nonionic surfactant (I) or a surfactant mixture comprising injecting at least one nonionic surfactant (I) through at least one injection well into a mineral oil deposit and crude oil is withdrawn from the deposit through at least one production well, wherein the at least one surfactant (I) or the surfactant mixture comprising at least one surfactant (I) has been dissolved in liquid or supercritical CO₂ and is injected and/or has been dissolved in an aqueous medium and is injected, the deposit has a deposit temperature of 15° C. to 140° C., the deposit water has a salinity of 20 000 ppm to 350 000 ppm, the density of the CO₂ under deposit conditions is 0.65 g/ml to 0.95 g/ml, and wherein the at least one nonionic surfactant is an alk(en)yl polyglucoside of the general formula (I)
R¹—O—(R²)ₚ—H (I)
where
R¹ is a linear or branched, saturated or unsaturated aliphatic hydrocarbyl radical having 8 to 18 carbon atoms,
R² represents sugar units having 5 or 6 carbon atoms, and
p is a number from 1 to 5.

31. The method according to claim 30, wherein R² comprises glucose units.

32. The method according to claim 30, wherein R¹ comprises linear alkyl and/or alkenyl radicals having 8 to 16 carbon atoms.

33. The method according to claim 32, wherein the surfactants (I) comprise a mixture of at least two surfactants having different R¹ radicals, where at least n-dodecyl and n-tetradecyl radicals are present.

34. The method according to claim 30, wherein the cloud point of the surfactant (I) used or of the surfactant mixture comprising at least one surfactant (I) used is at least 1° C. above the deposit temperature, the cloud point being determined in deposit water and at the concentration of the surfactant in the aqueous medium to be injected or the concentration in the liquid or supercritical CO₂ to be injected.

35. The method according to claim 34, wherein the cloud point of the surfactant (I) used or of the surfactant mixture comprising at least one surfactant (I) used is at least 3° C. above the deposit temperature.

36. The method according to claim 30, wherein the deposit water has a salinity of 35 000 ppm to 200 000 ppm.

37. The method according to claim 30, wherein the deposit temperature is 35° C. to 100° C.

38. The method according to claim 30, wherein the density of the CO₂ under deposit conditions is 0.70 g/ml to 0.90 g/ml.

39. The method according to claim 30, wherein the method involves a surfactant mixture at least comprising a nonionic surfactant (I) and a different nonionic surfactant (II) of the general formula
R³—(OCR⁴R⁵CR⁶R⁷)ₓ—(OCH₂CHR⁸)_{y}—(OCH₂CH₂)_{z}—OH (II)
where
R³ is a branched or linear, saturated or unsaturated aliphatic hydrocarbyl radical having 8 to 22 carbon atoms, and
R⁴, R⁵, R⁶, R⁷ are each H or a linear or branched alkyl radical having 1 to 8 carbon atoms, with the proviso that the sum total of the carbon atoms of the R⁴+R⁵+R⁶+R⁷ radicals is 2 to 8,
R⁸ is methyl,
x is a number from 0 to 5,
y is a number from 1 to 15,
z is a number from 1 to 30,
where the —OCR⁴R⁵CR⁶R⁷—, —OCH₂CHR⁸— and —OCH₂CH₂— radicals, to an extent of at least 90%, are arranged in the form of blocks in the sequence specified in formula (II), and where the sum total of x+y+z is values of 5 to 35, with the proviso that z≧(x+y).

40. The method according to claim 39, wherein R³ has 8 to 14 carbon atoms.

41. The method according to claim 39, wherein R³ is a branched C₁₀-alkyl radical of the formula C₅H₁₁—CH(C₃H₇)—CH₂—, where at least 70 mol % of the C₅H₁₁— radicals are an n-C₅H₁₁— radical.

42. The method according to claim 41, wherein
70 to 99 mol % of the C₅H₁₁— radicals are n-C₅H₁₁— radicals, and
1 to 30 mol % of the C₅H₁₁— radicals are C₂H₅CH(CH₃)CH₂— radicals and/or CH₃CH(CH₃)CH₂CH₂— radicals.

43. The method according to claim 41, wherein the C₃H₇— radicals are n-C₃H₇— radicals.

44. The method according to claim 39, wherein R¹ is a 2-propyl-n-heptyl radical H₃CCH₂CH₂CH₂CH₂CH(n-C₃H₇)CH₂—.

45. The method according to claim 39, wherein z≧2(x+y).

46. The method according to claim 39, wherein x=0.

47. The method according to claim 39, wherein the weight ratio of surfactant (I)/surfactant (II) in the surfactant mixture is 4:1 to 19.

48. The method according to claim 30, wherein it involves a surfactant mixture at least comprising a nonionic ionic surfactant (I) and a different nonionic surfactant (III) of the general formula
R⁹—C₆H₄—O—(OCR⁴R⁵CR⁶R⁷)ᵤ—(OCH₂CHR⁸)ᵥ—(OCH₂CH₂)_{w}—OH (III)
where
R⁹ is a branched or linear alkyl radical having 8 to 12 carbon atoms, and
R⁴, R⁵, R⁶, R⁷ and R⁸ are each as defined above,
U is a number from 0 to 5,
is a number from 0 to 15,
is a number from 5 to 30,
where the —OCR²R³CR⁴R⁵—, —OCH₂CHR⁶— and —OCH₂CH₂— radicals, to an extent of at least 90%, are arranged in the form of blocks in the sequence specified in formula (III), and where the sum total of u+v+w is values of 5 to 35, with the proviso that w>(u+v).

49. The method according to claim 48, wherein the weight ratio of surfactant (I)/surfactant (III) in the surfactant mixture is 4:1 to 1:9.

50. The method according to claim 30, wherein the surfactant used or the surfactant mixture is injected into the deposit as a solution in liquid or supercritical CO₂, where the concentration of all the surfactants together is 0.02 to 2% by weight based on the solution of liquid or supercritical CO₂.
